(19) United States
(12) Patent Application Publication
(10) Pub. No.: US 2011/0130465 A1
(43) Pub. Date: Jun. 2, 2011

(54) COATINGS FOR PREVENTION OF BIOFILMS

(75) Inventors: Jeffrey L. Dalsin, Verona, WI (US); Arinne N. Lyman, Fitchburg, WI (US)

(73) Assignee: NERITES CORPORATION, Madison, WI (US)

(21) Appl. No.: 12/955,637

(22) Filed: Nov. 29, 2010

Related U.S. Application Data
(60) Provisional application No. 61/265,637, filed on Dec. 1, 2009.

(51) Int. Cl. A01N 33/02; A01P 1/00

(52) U.S. Cl. 514/654

(57) ABSTRACT

This invention is directed to a method to reduce microbial fouling on a surface. The present invention provides antifouling coatings similar to the protein glues secreted by marine mussels for adhesion to underwater substrates.

### CROSS-REFERENCE TO RELATED APPLICATION

The present Application claims priority to U.S. Provisional Application Ser. No. 61/265,637 filed Dec. 1, 2009, the entirety of which is herein incorporated by reference.

### FIELD OF THE INVENTION

The invention is directed to polymer coatings for the prevention of biofilms in dental unit waterlines (DUWLs) and on urinary stent and catheter material.

### BACKGROUND OF THE INVENTION

Bacterial fouling of medical devices continues to be a persistent problem in multiple areas of medicine, and has a significant impact on healthcare costs annually. The present invention provides methods and kits to inhibit microbial fouling of the lumen of dental unit waterlines (DUWL), as well as bacterial contamination and encrustation of urinary stents and catheters.

### SUMMARY OF THE INVENTION

The present invention provides antifouling coatings similar to the protein glues secreted by marine mussels for adhesion to underwater substrates (FIG. 1). These adhesive compounds solidify rapidly, and enable the mussel to anchor itself to various surfaces in a wet, turbulent, and saline environment. A component identified in mussel adhesive proteins (MAPs) is 3,4-dihydroxyphenylalanine (DOPA). In some embodiments of the present invention, DOPA and DOPA-like moieties are coupled to antifouling polymers such as poly (ethylene glycol) (PEG). In certain embodiments, these polymer constructs are applied to dental unit waterline tubing, and to urinary stent and catheter materials, through a simple dip-coat process to reduce the adhesion of multiple microbial species.

These and other features and advantages of the present invention will be set forth or will become more fully apparent in the description that follows and in the appended claims. The features and advantages may be realized and obtained by means of the compositions and combinations particularly pointed out in the appended claims. Furthermore, the features and advantages of the invention may be learned by the practice of the invention or will be apparent from the description, as set forth hereinafter

### BRIEF DESCRIPTION OF THE FIGURES

Various exemplary embodiments of the compositions and methods according to the invention will be described in detail, with reference to the following figures wherein:

FIG. 1. shows antifouling coatings.

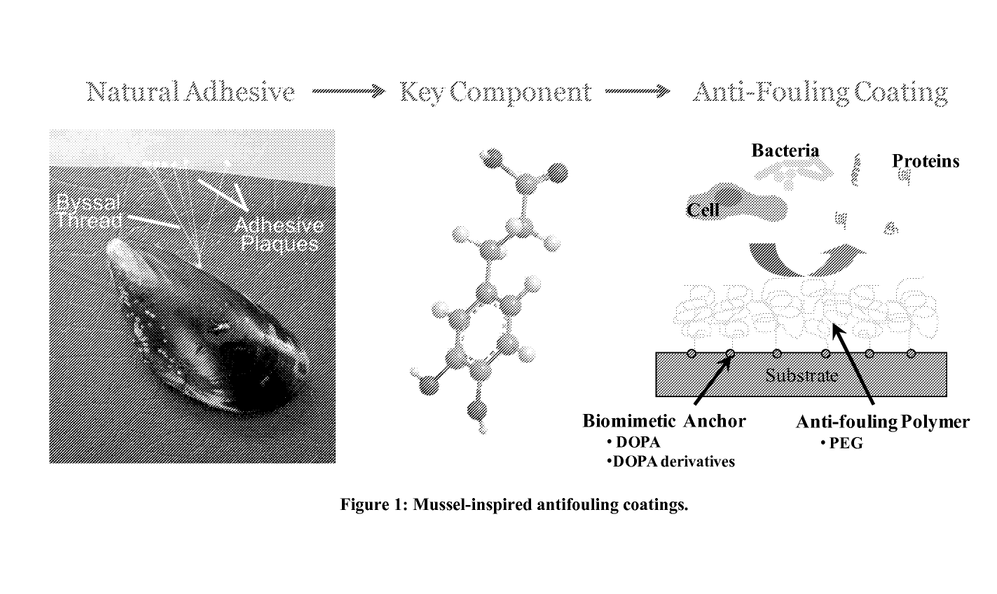

FIG. 2. shows S. aureus attachment on uncoated and coated DUWL PU surfaces.

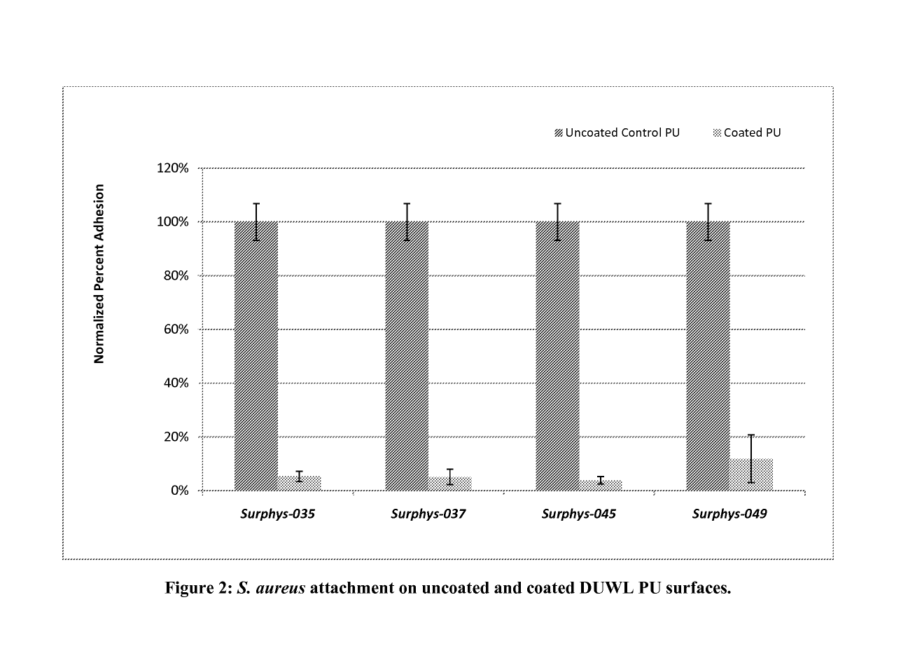

FIG. 3. shows bacterial attachment on uncoated and coated stent material PU surfaces.

FIG. 4. shows bacterial attachment on uncoated and coated catheter material (PDMS) surfaces.

FIG. 5. shows p(EG600EG10kb-g-DH4), Surphys-035.

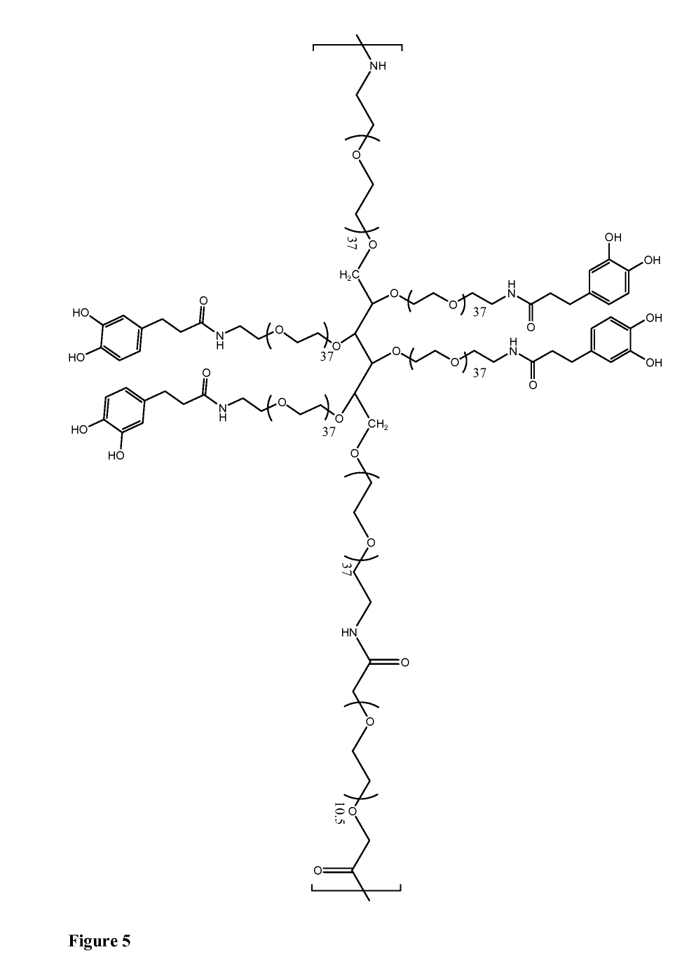

FIG. 6. shows p(EG600EG15kb-g-DH4), Surphys-037.

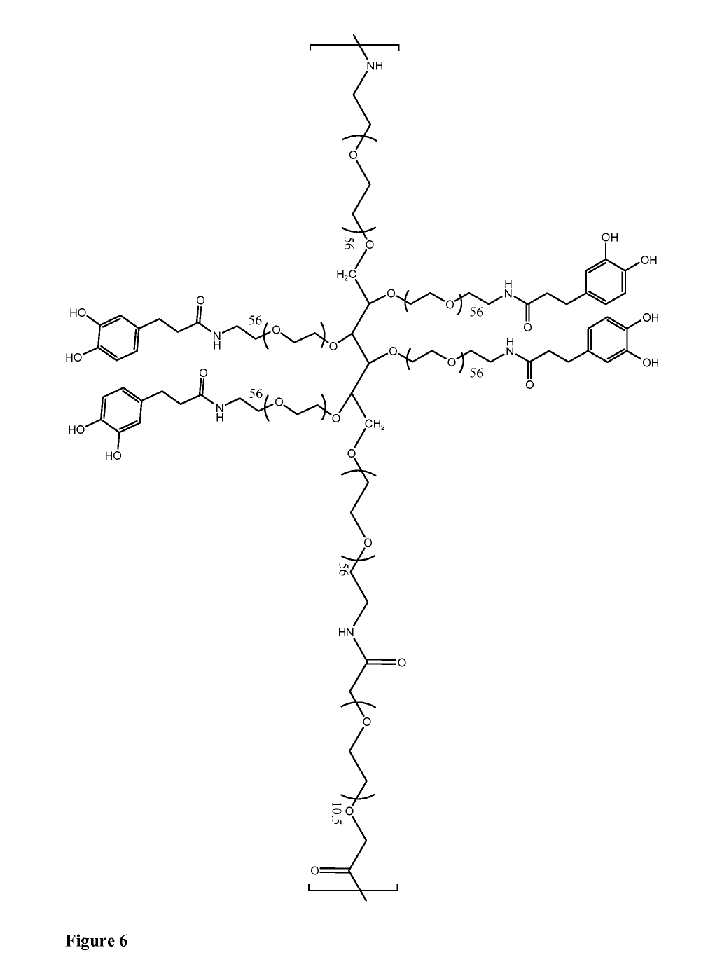

FIG. 7. shows p(EG600EG20kb-g-DH4), Surphys-045.

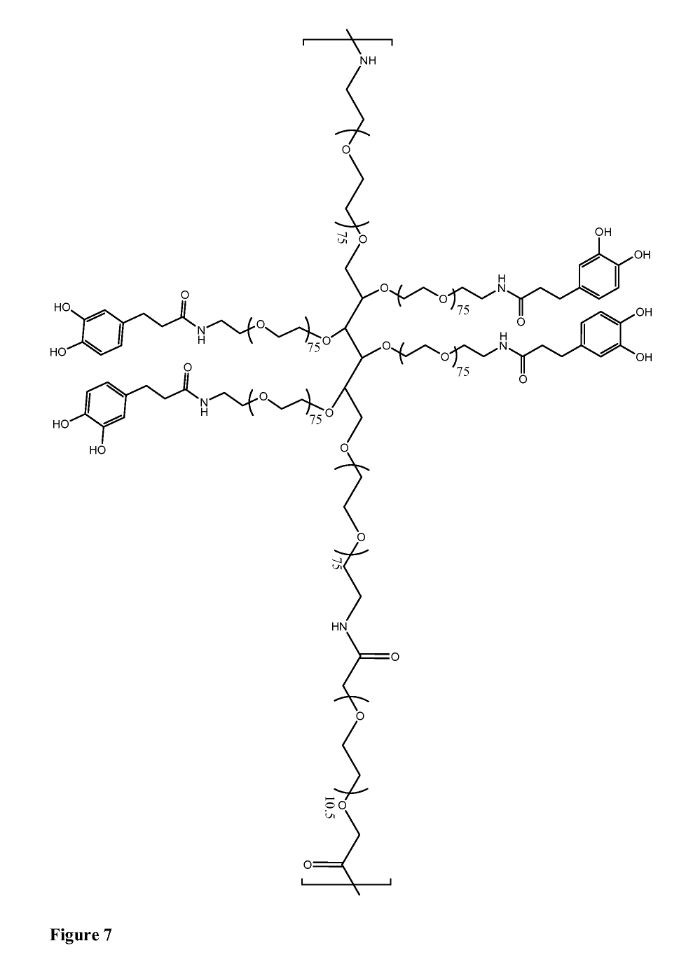

FIG. 8. Shows p(EG600EG20kb-g-DOPA4), Surphys-049.

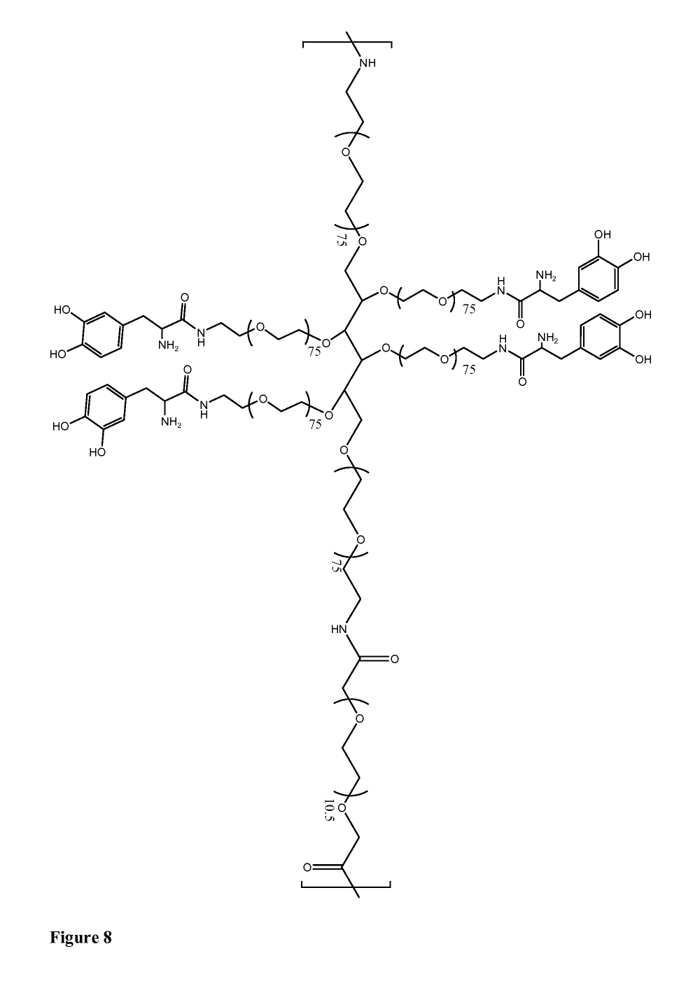

### DETAILED DESCRIPTION OF EXEMPLARY EMBODIMENTS

The present invention provides antifouling polymers comprising constructs of linear conjugates of PEG and DOPA. In experimentation conducted in furtherance of the present invention, it was found that using a branched PEG polymer increases the effectiveness of the antifouling coatings. In some embodiments, the molecular weight of the PEG segments is varied for different applications. Poly(ethylene glycol) based polymers functionalized with catchol have been evaluated on materials used in both dentistry and urology. For DUWL applications, the ability of the polymer coatings to reduce the attachment of common DUWL pathogens has been demonstrated, as has the compatibility of the polymer coatings with available antimicrobial DUWL treatments including Mint-A-Kleen (Anodia Systems), ICX (A-Dec), VistaTab (Vista Research Group), and Vista Clean (Vista Research Group). For urological applications, the performance of the polymer coatings against both bacterial adhesion and encrustation in urine has been demonstrated.

Staphylococcus aureus and Pseudomonas aeruginosa are two common DUWL pathogens which dental workers and patients may come in contact with via the spray of water from waterlines. In some embodiments, polymer coatings demonstrate strong resistance against S. aureus attachment on DUWL polyurethane (PU) tubing, with reductions of 90% or greater compared to control surfaces.

The antifouling coatings for DUWL were also evaluated in conjunction with common cleansers used to remove biofilm build-up. Coated DUWL polyurethane (PU) substrates were subjected to typical cleaning regimens of four common DUWL cleansers, and subsequently challenged with bacterial suspensions of S. aureus and P. aeruginosa to test coating integrity. DUWL cleansers did not disturb the DOPA-substrate interaction, and in some cases, improved antifouling ability over the coated substrates not subjected to any treatment (Table 1), providing a synergistic effect between the coating and the active ingredient in the cleansers.

TABLE 1
Reduction in attachment of DUWL pathogens on coated DUWL PU substrates
after treatment with various DUWL cleansers.

| | % Reduction Compared to Uncoated PU | | | | | | | |
|---|---|---|---|---|---|---|---|---|
| | Surphys-035 | | Surphys-037 | | Surphys-045 | | Surphys-049 | |
| | S. aureus | P. aerug. | S. aureus | P. aerug. | S. aureus | P. aerug. | S. aureus | P. aerug. |
| No Treatment | 85.5% | none | 85.3% | none | 88.1% | 48.3% | 93.9% | 54.4% |
| Mint-A-Kleen | 95.1% | none | 94.9% | none | 78.6% | 65.0% | 87.3% | 93.6% |
| ICX | 90.2% | none | 97.0% | 57.0% | 89.3% | 78.7% | 95.4% | 89.8% |
| VistaTabC | 89.4% | none | 80.8% | 6.9% | 89.5% | 74.4% | 92.6% | 70.9% |
| VistaCleanD | 92.1% | none | 86.7% | 17.1% | 91.4% | 84.0% | 97.7% | 72.4% |

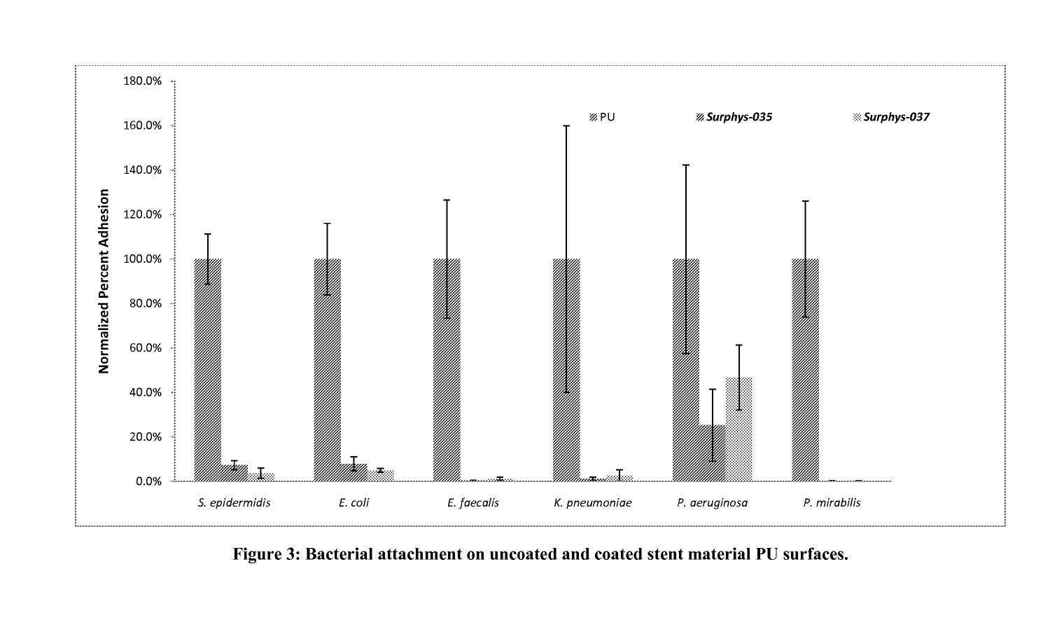

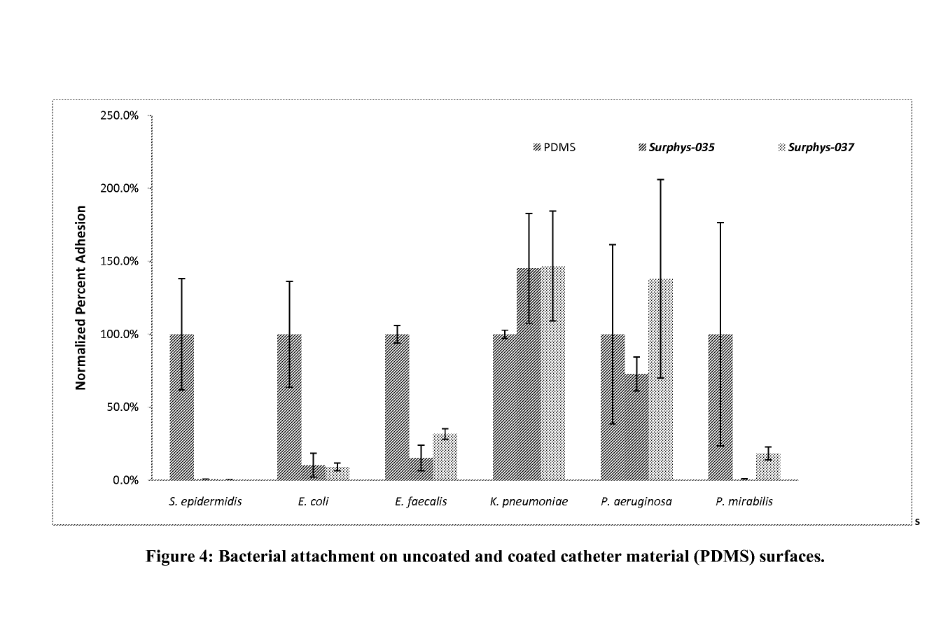

Adhesion of six common uropathogens (Staphylococcus epidermidis, Escherichia coli, Proteus mirabilis, Pseudomonas aeruginosa, Streptococcus pneumonia and Enterococcus faecalis) was evaluated on coated and uncoated urinary stent (PU) and catheter (polydimethylsiloxane; PDMS) materials. Among all the coatings tested, Surphys-035 and Surphys-037 were found to perform the best on both PU and PDMS surfaces. On PU surfaces, Surphys-035 and Surphys-037 exhibited significant antifouling activity against the attachment of all six uropathogens, with >90% reduction frequently observed (FIG. 3). On PDMS surfaces, Surphys-035 and Surphys-037 demonstrated excellent reduction on the adhesion of other tested bacterial species, particularly S. epidermidis and P. mirabilis, two principal organisms associated with urinary tract infections (FIG. 4).

Coated and uncoated urinary stent segments were immersed into artificial urine for 7 days for encrustation evaluation. Encrustation was physically removed from each stent segment and weighed. Results showed that stents coated with Surphys-035 and Surphys-037 demonstrated reduction of encrustation in the urine.

Coupling anchoring groups to antifouling polymers significantly reduces bacterial attachment to medical devices. In other embodiments, the antifouling coatings of the present invention prevent bacterial attachment to other types of implantable devices. In further embodiments, the antifouling compounds of the present invention are applied to surfaces in healthcare facilities (e.g., keyboards, elevator buttons, etc.) to prevent the spread of infection.

While this invention has been described in conjunction with the various exemplary embodiments outlined above, various alternatives, modifications, variations, improvements and/or substantial equivalents, whether known, or that are or may be presently unforeseen, may become apparent to those having at least ordinary skill in the art. Accordingly, the exemplary embodiments according to this invention, as set forth above, are intended to be illustrative not limiting, various changes may be made without departing from the spirit and scope of the invention. Therefore, the invention is intended to embrace all known or later-developed alternatives, modifications, variations, improvements and/or substantial equivalents of these exemplary embodiments.

What is claimed is:

1. A method to reduce microbial fouling on a surface, comprising:
a) providing a surface;
b) providing a multihydroxy phenyl derivative (DHPD)-poly(ethylene glycol) polymer;
c) applying an effective amount of said multihydroxy phenyl derivative (DHPD)-poly(ethylene glycol) polymer to surface; and
d) reducing said microbial fouling on said surface.

2. The method of claim 1, wherein said surface is the surface of a medical device.

3. The method of claim 2, wherein said medical device is a dental unit waterline (DUWL).

4. The method of claim 2, wherein said medical device is a urologic device.

5. The method of claim 4, wherein said urologic device is selected from the group consisting of a urinary stent or catheter.

6. The method of claim 1, further comprising providing a cleanser.

7. The method of claim 1, wherein said microbial fouling is bacterial fouling.

8. A kit comprising:
a) a surface susceptible to microbial biofilm fouling;
b) a multihydroxy phenyl derivative (DHPD)-poly(ethylene glycol) polymer; and
c) an apparatus for dispensing said a multihydroxy phenyl derivative (DHPD)-poly(ethylene glycol) polymer.

9. The kit of claim 8, further comprising a cleanser.
